(19) United States
(12) Patent Application Publication
(10) Pub. No.: US 2023/0331186 A1
(43) Pub. Date: Oct. 19, 2023

(54) WEBBING TAKE-UP DEVICE

(71) Applicant: KABUSHIKI KAISHA TOKAI-RIKA-DENKI-SEISAKUSHO, Aichi (JP)

(72) Inventors: Hayato UCHIBORI, Aichi (JP); Yoshiteru SAKAGUCHI, Aichi (JP); Yuta SUZUKI, Aichi (JP); Tomoya YOKOI, Aichi (JP)

(21) Appl. No.: 18/025,592

(22) PCT Filed: Jun. 17, 2021
(86) PCT No.: PCT/JP2021/023119

§ 371 Date: Mar. 9, 2023

(30) Foreign Application Priority Data
Sep. 25, 2020 (JP) 2020-161485

(51) Int. Cl. B60R 22/46

(52) U.S. Cl. CPC B60R 22/4633

(57) ABSTRACT

In this webbing take-up device, a first straight portion is set between a first bend portion and a mounting portion of a cylinder, and an axial direction base end portion of a moving member disposed inside the cylinder is disposed inside the first straight portion. Because of this, when the axial direction base end portion of the moving member extends and contracts in the axial direction, it does not receive strong resistance from the cylinder. Because of this, the axial direction base end portion of the moving member can extend and contract in the axial direction, and extension and contraction in the axial direction on the axial direction distal end side of the moving member can be inhibited.

### TECHNICAL FIELD

The present invention relates to a webbing take-up device where a spool is rotated in a take-up direction as a result of a rotational member being rotated.

### BACKGROUND ART

For example, the webbing take-up device disclosed in International Publication No. 2012/143090 includes a tube appropriately bent along a frame. A drive unit is provided on an axial direction base end portion of the tube, and a flexible rodlike force-transmitting element is disposed inside the tube. When the drive unit is activated, a gas is supplied to the inside of the tube. The force-transmitting element is moved by the pressure of the gas toward an axial direction distal end side of the tube. A pinion is disposed on the outer side of the axial direction distal end portion of the tube. The pinion is coupled to a spool, and when the force-transmitting element moved by the pressure of the gas toward the axial direction distal end side of the tube comes outside the tube, the force-transmitting element engages with the pinion and causes the pinion to rotate. In this way, when the pinion is rotated, the spool is rotated in a take-up direction and a webbing is taken up thereon.

In this connection, the force-transmitting element disposed inside the tube extends and contracts with changes in temperature and humidity. When the axial direction base end side of the force-transmitting element is disposed in the bend portion of the tube, the end portion on the axial direction base end side interferes with the bend portion of the tube such that the force-transmitting element extends out toward the axial direction distal end side, and by repeated extension and contraction the axial direction distal end side of the force-transmitting element moves to the pinion side. For this reason, it is necessary to dispose the force-transmitting element with enough leeway so that the axial direction distal end of the force-transmitting element does not contact the pinion, and it is necessary to lengthen the total length of the tube or shorten the force-transmitting element.

### SUMMARY OF INVENTION

### Technical Problem

In consideration of the above circumstances, it is an object of the present invention to obtain a webbing take-up device that can inhibit extension on an axial direction distal end side of a moving member.

### Solution to Problem

A webbing take-up device of a first aspect of the invention includes: a spool on which a webbing of a seat belt device is taken up as a result of the spool being rotated in a take-up direction: a rotational member that rotates to one side, whereby the spool is rotated in the take-up direction; a tubular cylinder whose axial direction distal end side is open, in whose axial direction base end portion a bend portion is set, and in which a straight portion is set on an axial direction base end side of the bend portion; a fluid supply unit that is provided on the axial direction base end side of the cylinder and supplies a fluid to an inside of the cylinder at a time of a vehicle emergency; and a moving member that is provided inside the cylinder, is moved toward the axial direction distal end side of the cylinder by pressure of the fluid, causes the rotational member to rotate to one side as a result of being moved in a state in which teeth of the rotational member are engaged with the moving member, and whose portion on the axial direction base end side of the cylinder is inside the straight portion of the cylinder.

In the webbing take-up device of the first aspect of the invention, the fluid supply unit is provided on the axial direction base end side of the cylinder, and when the fluid supply unit is activated at the time of a vehicle emergency, the fluid is supplied to the inside of the cylinder. When the internal pressure in the cylinder is raised because of this, the moving member provided inside the cylinder is moved toward the axial direction distal end side of the cylinder. When the moving member is moved toward the axial direction distal end side of the cylinder and the moving member comes out from the opening on the axial direction distal end side of the cylinder, the moving member engages with the teeth of the rotational member. Because of this, the rotational member is rotated to one side. When the rotational member is rotated to one side, the spool is rotated in the take-up direction, and because of this the webbing of the seat belt device is taken up on the spool.

Furthermore, the bend portion is set in the axial direction base end portion of the cylinder, and the straight portion is set on the axial direction base end side of the bend portion. The portion of the moving member on the axial direction base end side of the cylinder is inside the straight portion of the cylinder. For this reason, the portion of the moving member on the axial direction base end side of the cylinder is straight following the straight portion of the cylinder and extends toward and contracts from the axial direction base end side of the moving member due to changes in temperature and humidity. Because of this, extension on the axial direction distal end side of the moving member can be inhibited.

A webbing take-up device of a second aspect of the invention is the webbing take-up device of the first aspect, wherein an axial direction base end portion of the moving member in the cylinder has a portion whose radial dimension in a direction orthogonal to an axis of the moving member is enlarged over that of an axial direction distal end portion of the moving member.

In the webbing take-up device of the second aspect of the invention, the axial direction base end portion of the moving member in the cylinder has a radial dimension in the direction orthogonal to the axis of the moving member that is enlarged over that of the axial direction distal end portion of the moving member in the cylinder. For this reason, the axial direction base end portion of the moving member in the cylinder is less likely to become inclined due to changes in temperature and humidity. Because of this, the axial direction base end portion of the moving member in the cylinder extends toward and contracts from the axial direction base end side of the moving member due to changes in temperature and humidity. Because of this, extension on the axial direction distal end side of the moving member can be inhibited.

A webbing take-up device of a third aspect of the invention is the webbing take-up device of the second aspect, wherein the portion of the moving member whose radial dimension in the direction orthogonal to the axis of the moving member is enlarged is provided intermittently in at least one of an axial direction or a circumferential direction on an outer peripheral portion of the moving member.

In the webbing take-up device of the third aspect of the invention, the portion of the moving member whose radial dimension in the direction orthogonal to the axis of the moving member is enlarged is provided on the outer peripheral portion of the moving member intermittently in at least one of the axial direction and the circumferential direction of the moving member. For this reason, the portion of the moving member excluding the portion whose radial dimension in the direction orthogonal to the axis of the moving member is enlarged is smaller in diameter than the portion whose radial dimension in the direction orthogonal to the axis of the moving member is enlarged. For this reason, the portion whose radial dimension in the direction orthogonal to the axis of the moving member is small is less likely to receive resistance from the cylinder when it moves inside the cylinder.

A webbing take-up device of a fourth aspect is the webbing take-up device of the second or the third aspect, wherein the moving member has, on the axial direction distal end side of the portion of the moving member whose radial dimension in the direction orthogonal to the axis of the moving member is enlarged, a portion whose radial dimension in the direction orthogonal to the axis of the moving member is smaller than that of the portion whose radial dimension in the direction orthogonal to the axis of the moving member is enlarged.

In the webbing take-up device of the fourth aspect of the invention, the moving member has, on the axial direction distal end side of the portion whose radial dimension in the direction orthogonal to the axis of the moving member is enlarged, a portion whose radial dimension in the direction orthogonal to the axis of the moving member is smaller than that of the portion whose radial dimension in the direction orthogonal to the axis of the moving member is large. At the portion whose radial dimension in the direction orthogonal to the axis of the moving member is smaller than that of the portion whose radial dimension in the direction orthogonal to the axis of the moving member is large, stress concentrates and the portion bends easily. For this reason, bending occurs in the portion whose radial dimension in the direction orthogonal to the axis of the moving member is small, so bending is less likely to occur at the portion whose radial dimension in the direction orthogonal to the axis of the moving member is large.

A webbing take-up device of a fifth aspect of the invention is the webbing take-up device of any one of the first to the fourth aspects, wherein a plurality of bend portions are set in the cylinder along an axial direction of the cylinder.

In the webbing take-up device of the fifth aspect of the invention, a plurality of the bend portions are set in the cylinder along the axial direction of the cylinder. For this reason, the cylinder becomes planar or multidimensional, and the total length of the cylinder can be increased.

A webbing take-up device of a sixth aspect of the invention is the webbing take-up device of the fifth aspect, wherein three or more of the bend portions are set along the axial direction of the cylinder, and an axial direction of a bend in at least one of the bend portions intersects an axial direction of a bend in at least one of the other bend portions.

In the webbing take-up device of the sixth aspect of the invention, three or more of the bend portions are set along the axial direction of the cylinder. Furthermore, in this webbing take-up device, the axial direction of the bend in at least one of the bend portions intersects the axial direction of the bend in at least one of the other bend portions. For this reason, the cylinder becomes multidimensional, and the total length of the cylinder can be increased.

A webbing take-up device of a seventh aspect of the invention is the webbing take-up device of any one of the first to the sixth aspects, wherein, at the axial direction base end portion of the cylinder, an axial direction of the cylinder faces inward in a vehicle width direction.

In the webbing take-up device of the seventh aspect of the invention, at the axial direction base end portion of the cylinder, the axial direction of the cylinder faces inward in the vehicle width direction. In this connection, the inside of a center pillar opens inward in the vehicle width direction. For this reason, in a case where the webbing take-up device is provided in a center pillar, the axial direction base end portion of the cylinder faces the open side of the center pillar because the axial direction base end portion of the cylinder faces inward in the vehicle width direction. For this reason, the fluid supply unit can be attached to the axial direction base end portion of the cylinder after the webbing take-up device has been assembled to the center pillar.

A webbing take-up device of an eighth aspect of the invention is the webbing take-up device of any one of the first to the seventh aspect, comprising a sealing member that is provided at an axial direction base end portion of the moving member, is annular in a direction about an axis of the cylinder, and seals a gap between the cylinder and the moving member.

In the webbing take-up device of the eighth aspect of the invention, the sealing member is provided on the moving member. The sealing member is annular in a direction about the axis of the cylinder and seals a gap between the cylinder and the moving member. Here, the sealing member is provided on the axial direction base end portion of the moving member. For this reason, the axial direction base end of the moving member can be brought close to the fluid supply unit.

### Advantageous Effects of Invention

As described above, the webbing take-up device pertaining to the present invention can inhibit extension on the axial direction distal end side of the moving member.

### BRIEF DESCRIPTION OF DRAWINGS

FIG. 1 is an exploded perspective view of a webbing take-up device pertaining to a first embodiment.

FIG. 2 is a sectional view cut in a direction orthogonal to a vehicle front and rear direction.

FIG. 3 is a side view, looking inside a cover plate from a vehicle front direction, showing a state in which a moving member has come into abutment with a stopper.

FIG. 4 is a sectional view showing a mounting portion, a first straight portion, and a first bend portion of a cylinder.

FIG. 5 is a sectional view, corresponding to FIG. 4, showing a second embodiment.

FIG. 6 is a sectional view, corresponding to FIG. 4, showing a third embodiment.

FIG. 7 is a sectional view, corresponding to FIG. 4, showing a fourth embodiment.

FIG. 8 is a sectional view, corresponding to FIG. 4, showing a fifth embodiment.

FIG. 9 is a sectional view, corresponding to FIG. 4, showing a sixth embodiment.

FIG. 10 is a sectional view, corresponding to FIG. 4, showing a seventh embodiment.

FIG. 11 is a sectional view, corresponding to FIG. 4, showing an eighth embodiment.

FIG. 12 is a sectional view, corresponding to FIG. 4, showing a ninth embodiment.

FIG. 13 is a sectional view, corresponding to FIG. 4, showing a tenth embodiment.

FIG. 14 is a sectional view, corresponding to FIG. 4, showing an eleventh embodiment.

### DESCRIPTION OF EMBODIMENTS

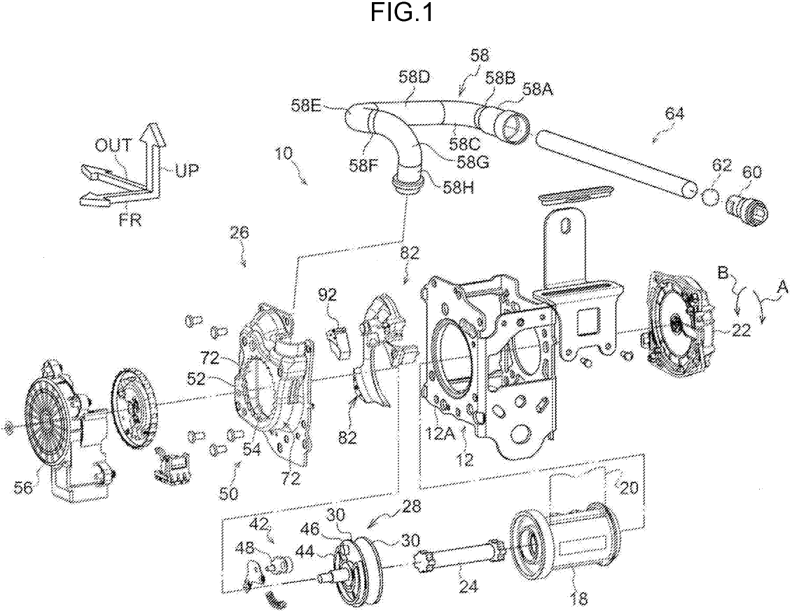

Next, embodiments of the invention will be described based on the drawings from FIG. 1 to FIG. 14. It will be noted that, in the drawings, arrow FR indicates a forward direction of a vehicle to which a webbing take-up device 10 is applied, arrow OUT indicates an outward direction in the vehicle width direction, and arrow UP indicates a vehicle upward direction. Furthermore, in the drawings, arrow A indicates a take-up direction, which is a rotational direction of a spool 18 when the spool 18 takes up a webbing 20, and arrow B indicates a pull-out direction opposite the take-up direction.

### Configuration of First Embodiment

As shown in FIG. 1, the webbing take-up device 10 pertaining to the present embodiment includes a frame 12. The frame 12 is secured to a vehicle lower portion of a center pillar (not shown in the drawings) serving as a vehicle body of the vehicle.

Furthermore, in the frame 12 is provided a spool 18. The spool 18 is formed in a substantially cylindrical shape and is rotatable about a center axis (the direction of arrow A and the direction of arrow B in FIG. 1). Anchored to the spool 18 is a lengthwise direction base end portion of a long band-like webbing 20, and when the spool 18 is rotated in the take-up direction (the direction of arrow A in FIG. 1), the webbing 20 is taken up from its lengthwise direction base end side on the spool 18. Furthermore, a lengthwise direction distal end side of the webbing 20 extends in the vehicle upward direction from the spool 18, passes through a slit hole formed in a through anchor (not shown in the drawings) supported on the center pillar on the vehicle upper side of the frame 12, and is looped back in the vehicle downward direction.

Moreover, the lengthwise direction distal end portion of the webbing 20 is anchored to an anchor plate (not shown in the drawings). The anchor plate is formed of a metal plate material such as iron and is secured, for example, to a floor (not shown in the drawings) of the vehicle or a skeletal member of a seat (not shown in the drawings) corresponding to the webbing take-up device 10.

Furthermore, a seat belt device for a vehicle to which the webbing take-up device 10 is applied includes a buckle device (not shown in the drawings). The buckle device is provided on the vehicle width direction inner side of the seat (not shown in the drawings) to which the webbing take-up device 10 is applied. When a tongue (not shown in the drawings) provided on the webbing 20 is engaged to the buckle device in a state in which the webbing 20 has been pulled across the body of an occupant sitting in the seat, the webbing 20 is secured on the body of the occupant.

Furthermore, as shown in FIG. 1, on the vehicle rear side of the frame 12 is provided a spring housing 22. Inside the spring housing 22 is provided a spool energizing member (not shown in the drawings) such as a flat spiral spring. The spool energizing member is directly or indirectly engaged with the spool 18, and the spool 18 is energized in the take-up direction (the direction of arrow A in FIG. 1) by energizing force of the spool energizing member.

Moreover, the webbing take-up device 10 includes a torsion bar 24 that configures a force limiter mechanism. The vehicle rear portion of the torsion bar 24 is disposed inside the spool 18 and is connected to the spool 18 in a state in which relative rotation with respect to the spool 18 is limited. In contrast, the vehicle front portion of the torsion bar 24 passes through a hole formed in the frame 12 and extends to the outside (the vehicle front side) of the frame 12.

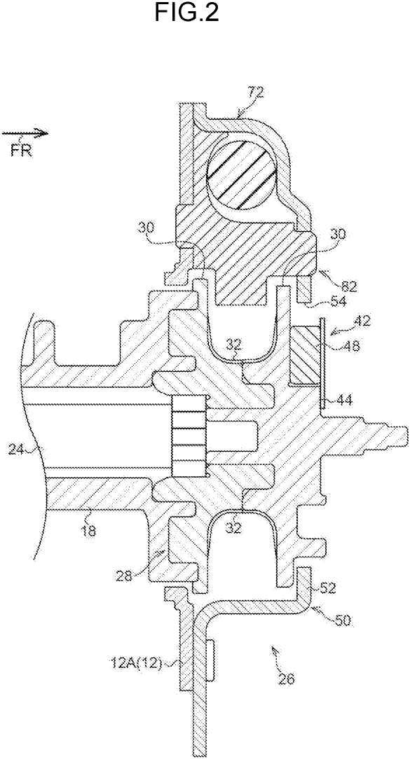

On the vehicle front side of the frame 12 is provided a rotational member 28 of a pretensioner 26. The rotational member 28 is disposed coaxially with respect to the spool 18. The vehicle front portion of the torsion bar 24 is coupled to the rotational member 28, and relative rotation of the rotational member 28 with respect to the vehicle front portion of the torsion bar 24 is limited. Furthermore, the rotational member 28 includes a pair of flange portions 30 that oppose each other in the vehicle front and rear direction. As shown in FIG. 2, between the pair of flange portions 30, plural teeth 32 are formed at a predetermined angle in a direction about the axis of the torsion bar 24.

Furthermore, the flange portion 30 on the vehicle front side among the pair of flange portions 30 serves as a lock base 44 of a lock mechanism 42. The lock base 44 includes a lock pawl 48. The lock pawl 48 is supported by a boss 46 formed on the lock base 44 and is swingable about the boss 46.

Meanwhile, secured to a leg plate 12A on the vehicle front side of the frame 12 is a cover plate 50 that configures both the lock mechanism 42 and the pretensioner 26. The cover plate 50 opens in the vehicle rearward direction, and a bottom plate 52 of the cover plate 50 opposes the frame 12 in a state in which it is spaced apart in the vehicle forward direction from the frame 12. In the bottom plate 52 is formed a ratchet hole 54. On the inner peripheral portion of the ratchet hole 54 are formed ratchet teeth, and when the lock pawl 48 of the lock base 44 is swung in one direction about the boss 46. the distal end portion of the lock pawl 48 meshes with the ratchet teeth of the ratchet hole 54. Because of this, rotation of the lock base 44 in the pull-out direction (the direction of arrow B in FIG. 1) is limited, and rotation of the spool 18 in the pull-out direction is indirectly limited.

Furthermore, on the vehicle front side of the cover plate 50 is provided a sensor holder 56 of the lock mechanism 42. The sensor holder 56 opens in the vehicle rearward direction and is secured to the frame 12 directly or indirectly via the cover plate 50. Inside the sensor holder 56 are housed parts configuring a sensor mechanism that detects an emergency state of the vehicle. When the sensor mechanism inside the sensor holder 56 is activated at the time of a vehicle emergency, the lock pawl 48 of the lock base 44 is swung in one direction about the boss 46 in conjunction with the rotation of the lock base 44 of the lock mechanism 42 in the pull-out direction.

Meanwhile, the webbing take-up device 10 includes a cylinder 58 serving as a tubular member that configures the pretensioner 26. The cylinder 58 is formed in a cylindrical shape and is appropriately bent in its axial direction middle portion. Specifically, on the vehicle rear side of the vehicle upper side of the frame 12 is provided a mounting portion 58A. The axial direction of the mounting portion 58A is generally linear along the vehicle width direction, and the mounting portion 58A opens inward in the vehicle width direction. A micro gas generator 60 (hereinafter the micro gas generator 60 will be called “the MGG 60”) serving as a fluid supply unit is inserted through the open end on the vehicle width direction inner side of the mounting portion 58A.

On the vehicle width direction outer side of the mounting portion 58A is formed a first straight portion 58B serving as a straight portion. The axial direction of the first straight portion 58B is generally linear along the vehicle width direction, and the axial direction base end (vehicle width direction inner end) of the first straight portion 58B is connected to the axial direction distal end (vehicle width direction outer end) of the mounting portion 58A. The axial direction distal end (vehicle width direction outer end) of the first straight portion 58B is connected to the axial direction base end of a first bend portion 58C serving as a bend portion. The axial direction middle portion of the first bend portion 58C is bent in a direction about an axis whose axial direction generally coincides with the vehicle up and down direction, and the axial direction distal end of the first bend portion 58C faces the vehicle forward direction. Connected to the axial direction distal end of the first bend portion 58C is the axial direction base end (vehicle rear end) of a second straight portion 58D.

The axial direction of the second straight portion 58D generally coincides with the vehicle front and rear direction along the vehicle width direction outer end of the frame 12. Connected to the axial direction distal end (vehicle front end) of the second straight portion 58D is the axial direction base end of a second bend portion 58E serving as a bend portion. The axial direction middle portion of the second bend portion 58E is bent in a direction about an axis whose axial direction generally coincides with the vehicle up and down direction, and the axial direction distal end of the second bend portion 58E faces inward in the vehicle width direction. Connected to the axial direction distal end of the second bend portion 58E is the axial direction base end (vehicle width direction outer end) of a third straight portion 58F.

The axial direction of the third straight portion 58F generally coincides with the vehicle width direction along the vehicle upper end of the leg plate 12A of the frame 12. Connected to the axial direction distal end (vehicle width direction inner end) of the third straight portion 58F is the axial direction base end of a third bend portion 58G serving as a bend portion. The axial direction middle portion of the third bend portion 58G is bent in a direction about an axis whose axial direction generally coincides with the vehicle front and rear direction, and the axial direction distal end of the second bend portion 58E faces the vehicle downward direction. Connected to the axial direction distal end of the third bend portion 58G is the axial direction base end (vehicle width direction outer end) of a fourth straight portion 58H. The axial direction of the fourth straight portion 58H generally coincides with the vehicle up and down direction along the vehicle width direction inner end of the leg plate 12A of the frame 12. and the axial direction distal end (vehicle lower end) of the fourth straight portion 58H is open.

The MGG 60 inserted into the mounting portion 58A of the cylinder 58 is electrically connected to an impact detection sensor provided in the vehicle via an ECU serving as a control unit (neither of which is shown in the drawings), and when a shock at the time of a vehicle impact is detected by the impact detection sensor, the MGG 60 is activated by the ECU, so that a gas which is one aspect of a fluid generated in the MGG 60, is supplied to the inside of the cylinder 58.

Inside the first straight portion 58B of the cylinder 58 of the pretensioner 26 is disposed a sealing ball 62 serving as a piston. The sealing ball 62 is formed of a synthetic resin material, and the shape of the sealing ball 62 in a state in which a load is not acting on the sealing ball 62 is substantially spherical. The inside space of the cylinder 58 is partitioned by the sealing ball 62 into an axial direction base end side of the sealing ball 62 and an axial direction distal end side of the sealing ball 62. When the MGG 60 is activated, the gas generated by the MGG 60 is supplied to the space in the cylinder 58 between the MGG 60 and the sealing ball 62. Because of this, when the internal pressure is raised in the space in the cylinder 58 between the MGG 60 and the sealing ball 62, the sealing ball 62 is moved toward the axial direction distal end side of the cylinder 58 and becomes compressed and deformed in the axial direction of the cylinder 58.

Furthermore, inside the cylinder 58 of the pretensioner 26 is disposed a moving member 64, and the lengthwise direction base end portion of the moving member 64 is disposed inside the first straight portion 58B of the cylinder 58. The moving member 64 is formed of a synthetic resin material and is deformable upon being subjected to an external force. The moving member 64 is disposed on the cylinder 58 axial direction distal end side of the sealing ball 62, and when the sealing ball 62 is moved toward the axial direction distal end side of the cylinder 58. the moving member 64 is pushed by the sealing ball 62 and moved toward the axial direction distal end side of the cylinder 58.

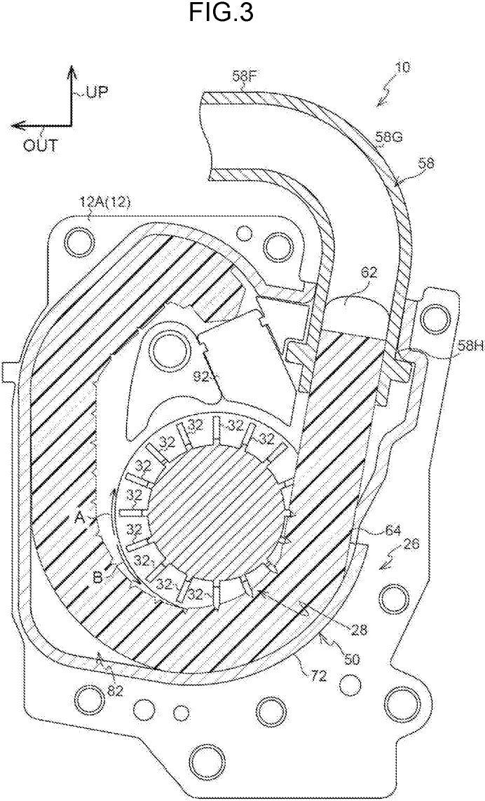

When the moving member 64 is further pushed by the sealing ball 62 and moved in a state in which the moving member 64 has reached the axial direction distal end of the fourth straight portion 58H of the cylinder 58, the moving member 64 comes out from the axial direction distal end of the cylinder 58 in the vehicle downward direction and enters the inside of the cover plate 50. When the moving member 64 is further moved in the vehicle downward direction in this state, as shown in FIG. 3, the lengthwise direction distal end portion of the moving member 64 comes into abutment with the teeth 32 of the rotational member 28. In this state, the teeth 32 are pushed in the vehicle downward direction by the moving member 64. whereby rotational force in the take-up direction (the direction of arrow A in FIG. 3) from the moving member 64 is applied to the rotational member 28. Because of this, the rotational member 28 is rotated in the take-up direction (the direction of arrow A in FIG. 3), and the moving member 64 is further moved in the vehicle downward direction by the pressure from the sealing ball 62.

In this way, the moving member 64 is moved in the vehicle downward direction and the rotational member 28 is rotated in the take-up direction, whereby the teeth 32 of the rotational member 28 stab the moving member 64. In this state, the moving member 64 is further moved in the vehicle downward direction, whereby rotational force in the take-up direction is further applied to the rotational member 28, and the rotational member 28 is further rotated in the take-up direction.

Meanwhile, as shown in FIG. 1 and FIG. 2, the cover plate 50 includes the bottom plate 52. The bottom plate 52 is platelike, and the thickness direction of the bottom plate 52 generally coincides with the vehicle front and rear direction (the direction of arrow FR and the opposite direction in FIG. 1 and FIG. 2). Furthermore, the cover plate 50 includes a side wall 72. The side wall 72 is provided along the outer peripheral portion of the bottom plate 52 of the cover plate 50, and as shown in FIG. 2 and FIG. 3, the rotational member 28 is disposed inside the side wall 72. Furthermore, as shown in FIG. 3, inside the cover plate 50 is provided a guide member 82. The moving member 64 that has gone down in the vehicle downward direction beyond the rotational member 28 is guided by the side wall 72 of the cover plate 50 and the guide member 82 and rises along the vehicle width direction outer side of the rotational member 28.

On the vehicle upper side of the rotational member 28 is disposed a stopper 92. The moving member 64 that has risen along the vehicle width direction outer side of the rotational member 28 pushes the stopper 92 from the vehicle upper side and the vehicle width direction outer side of the stopper 92. The stopper 92 pushed by the moving member 64 is moved in the vehicle downward direction and inward in the vehicle width direction and engages with the lengthwise direction base end side of the moving member 64. Because of this, the advance of the moving member 64 stops.

### Action and Effects of First Embodiment

Next, the action and effects of the present embodiment will be described.

In the webbing take-up device 10, when the MGG 60 of the pretensioner 26 is activated by the ECU at the time of a vehicle impact, which is one aspect of at the time of a vehicle emergency, the high-pressure gas is instantaneously supplied from the MGG 60 to the inside of the cylinder 58. When the sealing ball 62 is moved by the pressure of the gas toward the axial direction distal end side of the cylinder 58, the moving member 64 is pushed by the sealing ball 62 so that the moving member 64 is moved toward the axial direction distal end side of the cylinder 58.

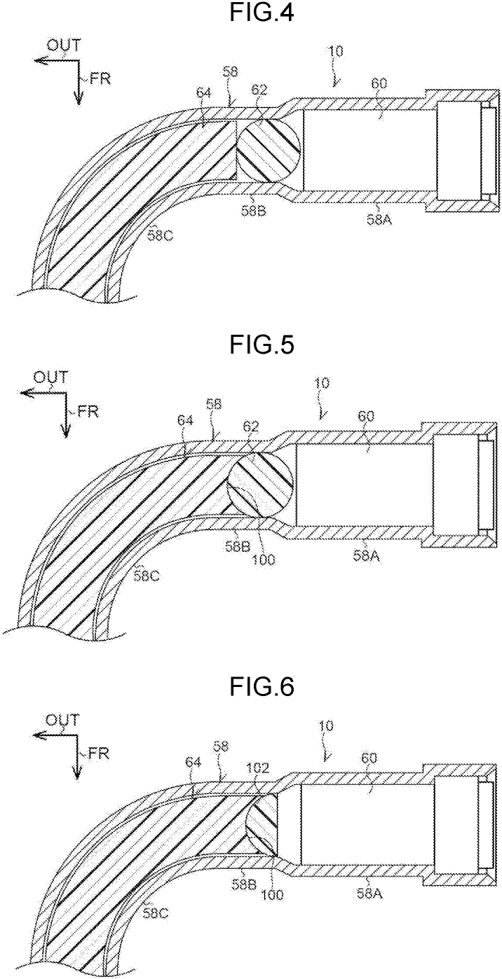

Because the moving member 64 is moved toward the axial direction distal end side, the moving member 64 comes out from the axial direction distal end of the cylinder 58 in the vehicle downward direction, and the teeth 32 of the rotational member 28 come into abutment with the moving member 64 (see FIG. 3). Because of this, the teeth 32 of the rotational member 28 are pushed in the vehicle downward direction by the moving member 64, whereby rotational force in the take-up direction (the direction of arrow A in FIG. 3, etc.) from the moving member 64 is applied to the rotational member 28. Because of this, the rotational member 28 is rotated in the take-up direction (the direction of arrow A in FIG. 4. etc.).

Moreover, among the plural teeth 32 of the rotational member 28, the teeth 32 on the pull-out direction side of the teeth 32 pushed by the moving member 64 eat into or stab the outer peripheral surface of the moving member 64 toward the radial direction medial side of the moving member 64 due to the rotation of the rotational member 28 in the take-up direction.

In this way, the moving member 64 that the teeth 32 have eaten into or stabbed is moved in the vehicle downward direction, whereby rotational force in the take-up direction is further applied to the rotational member 28, and as for the rotational member 28, the rotational member 28 is further rotated in the take-up direction. The rotation of the rotational member 28 in the take-up direction is transmitted via the torsion bar 24 to the spool 18. and the spool 18 is rotated in the take-up direction. Because of this, the webbing 20 is taken up on the spool 18, and the force with which the occupant is restrained by the webbing 20 is increased.

Meanwhile, when the moving member 64 is moved in the vehicle downward direction beyond the rotational member 28 as a result of the moving member 64 being pushed by the sealing ball 62, the moving member 64 is guided by the side wall 72 of the cover plate 50 and the guide member 82 and is moved in the vehicle upward direction. In this state, when the moving member 64 is further pushed by the sealing ball 62, the axial direction distal end of the moving member 64 becomes positioned on the vehicle upper side and the vehicle width direction outer side of the stopper 92. When the moving member 64 is further pushed by the sealing ball 62 from this state, the moving member 64 pushes the stopper 92 from the vehicle upper side and the vehicle width direction outer side of the stopper 92. Because of this, the stopper 92 is moved in the vehicle downward direction and inward in the vehicle width direction and engages with the portion of the moving member 64 on the axial direction base end side of the portion engaged with the rotational member 28. Because of this, the moving member 64 can be prevented from entirely coming out from the cylinder 58.

In this connection, in the present embodiment, the cylinder 58 includes the first straight portion 58B. and the axial direction base end side portion of the moving member 64 is inside the first straight portion 58B of the cylinder 58. The portion of the moving member 64 inside the first straight portion 58B experiences little catching due to increases or decreases in the temperature and humidity of the first straight portion 58B of the cylinder 58. For this reason, the portion of the moving member 64 inside the first straight portion 58B can extend and contract in the axial direction of the moving member 64. Because of this, extension of the axial direction distal end portion of the moving member 64 in the axial direction of the moving member 64 can be inhibited.

Because extension of the axial direction distal end portion of the moving member 64 toward the axial direction distal end side of the moving member 64 can be inhibited, the axial direction distal end of the moving member 64 can be disposed close to the teeth 32 of the rotational member 28, and the total length of the moving member 64 can be increased.

Furthermore, because the axial direction distal end of the moving member 64 can be disposed close to the teeth 32 of the rotational member 28, the time lag from when the MGG 60 is activated to when the rotational member 28 starts rotating can be reduced.

Moreover, because the total length of the moving member 64 can be lengthened, the sealing ball 62 can be prevented from coming out from the axial direction distal end portion of the cylinder 58 when the moving member 64 has been moved.

Furthermore, because extension of the axial direction distal end portion of the moving member 64 toward the axial direction distal end side of the moving member 64 can be inhibited, the control range of the position of the moving member 64 with respect to the cylinder 58 in the process of assembling the moving member 64 inside the cylinder 58 can be increased.

Moreover, in the present embodiment, the cylinder 58 includes the first bend portion 58C. the second bend portion 58E, and the third bend portion 58G. At the first bend portion 58C and the second bend portion 58E, the cylinder 58 is bent in a direction about an axis whose axial direction coincides with the vehicle up and down direction, and at the third bend portion 58G, the cylinder 58 is bent in a direction about an axis whose axial direction coincides with the vehicle front and rear direction. In this way, the cylinder 58 is multidimensionally (three-dimensionally) bent, so the cylinder 58 can be sufficiently lengthened, and the webbing take-up device 10 can be made three-dimensionally compact.

Furthermore, in the present embodiment, at the axial direction base end portion of the cylinder 58, the axial direction of the cylinder 58 faces inward in the vehicle width direction. In this connection, the vehicle lower portion of the center pillar opens inward in the vehicle width direction. For this reason, in a case where the webbing take-up device 10 is provided in the center pillar, the axial direction base end portion of the cylinder 58 faces the open side of the center pillar because the axial direction base end portion of the cylinder 58 faces inward in the vehicle width direction. For this reason, the MGG 60 can be attached to the axial direction base end portion of the cylinder 58 after the webbing take-up device 10 has been assembled to the center pillar.

### Second Embodiment

As shown in FIG. 5, in the present embodiment, a recess portion 100 is formed in the axial direction base end portion of the moving member 64, The recess portion 100 is curved in the shape of a recess with a center of curvature on the axial direction base end side of the moving member 64 along the center axis of the moving member 64. The radius of curvature of the recess portion 100 is equal to or greater than the radial dimension of the sealing ball 62, and part of the sealing ball 62 along the axial direction of the first straight portion 58B of the cylinder 58 is inside the recess portion 100.

In the present embodiment with the above configuration, the sealing ball 62 and the moving member 64 overlap each other along the axial direction of the first straight portion 58B of the cylinder 58. For this reason, the length of the first straight portion 58B of the cylinder 58 can be shortened.

Furthermore, except that the recess portion 100 is formed in the axial direction base end portion of the moving member 64, the configuration of the present embodiment is basically the same as the configuration of the first embodiment. Consequently, the present embodiment can basically obtain the same effects as the first embodiment.

### Third Embodiment

As shown in FIG. 6, in the present embodiment, a sealing member 102 is provided instead of the sealing ball 62. The sealing member 102 has a substantially hemispherical shape that projects toward the axial direction distal end side of the first straight portion 58B of the cylinder 58. The portion of the sealing member 102 that projects toward the axial direction distal end side of the first straight portion 58B of the cylinder 58 is housed inside the recess portion 100.

In the present embodiment with the above configuration, the portion of the sealing member 102 that projects toward the axial direction distal end side of the first straight portion 58B of the cylinder 58 is housed inside the recess portion 100. For this reason, the sealing member 102 and the moving member 64 overlap each other along the axial direction of the first straight portion 58B of the cylinder 58. For this reason, the length of the first straight portion 58B of the cylinder 58 can be further shortened.

Furthermore, except that the recess portion 100 is formed in the axial direction base end portion of the moving member 64, the configuration of the present embodiment is basically the same as the configuration of the first embodiment. Consequently, the present embodiment can basically obtain the same effects as the first embodiment.

### Fourth Embodiment

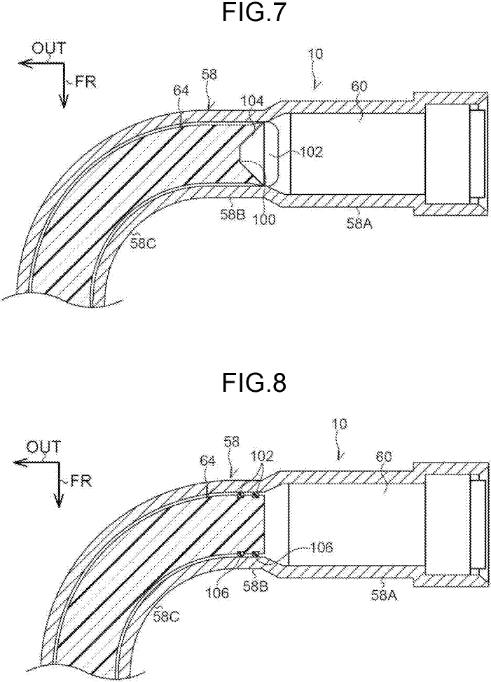

As shown in FIG. 7. the sealing member 102 of the present embodiment includes a frustoconical portion 104. The frustoconical portion 104 has a substantially frustoconical shape whose radial dimension orthogonal to the axial direction of the first straight portion 58B becomes shorter heading toward the axial direction distal end side of the first straight portion 58B of the cylinder 58. In correspondence to this frustoconical portion 104, the inside of the recess portion 100 of the moving member 64 has a substantially frustoconical shape whose radial dimension becomes larger heading toward the axial direction base end side of the first straight portion 58B of the cylinder 58. Moreover, at the end portion of the recess portion 100 of the moving member 64 on the axial direction base end side of the first straight portion 58B of the cylinder 58, the outer diameter dimension is enlarged, and at the end of the recess portion 100 on the axial direction base end side of the first straight portion 58B, the outer diameter dimension of the moving member 64 is equal to the inner diameter dimension of the first straight portion 58B of the cylinder 58.

In the present embodiment with this configuration, when the MGG 60 is activated and the sealing member 102 is moved toward the axial direction distal end side of the cylinder 58. the recess portion 100 of the moving member 64 enters the gap between the inner peripheral portion of the cylinder 58 and the outer peripheral portion of the sealing member 102. Because of this also, the sealing member 102 is less likely to come out from the axial direction distal end of the cylinder 58.

Furthermore, the configuration of the present embodiment is basically the same as the configuration of the second embodiment. Consequently, the present embodiment can basically obtain the same effects as the second embodiment.

It will be noted that, in the third embodiment, the sealing member 102 had a substantially hemispherical shape that projected toward the axial direction distal end side of the first straight portion 58B of the cylinder 58. Furthermore, in the fourth embodiment, the sealing member 102 had a substantially frustoconical shape whose radial dimension orthogonal to the axial direction of the first straight portion 58B became shorter heading toward the axial direction distal end side of the first straight portion 58B of the cylinder 58. However, the shapes of the sealing member 102 and the recess portion 100 may be shapes other than a substantially hemispherical shape and a substantially frustoconical shape.

### Fifth Embodiment and Sixth Embodiment

As shown in FIG. 8, in a fifth embodiment, two grooves 106 are formed in the outer peripheral portion of the axial direction base end portion of the moving member 64. The grooves 106 are annular about the center axis of the axial direction base end portion of the moving member 64 and open at the outer peripheral portion of the moving member 64 in a direction orthogonal to the axial direction of the moving member 64. Inside these grooves 106 are disposed sealing members 102. The sealing members 102 are annular and are in pressure contact with the insides of the first grooves 106 and the inner peripheral portion of the cylinder 58.

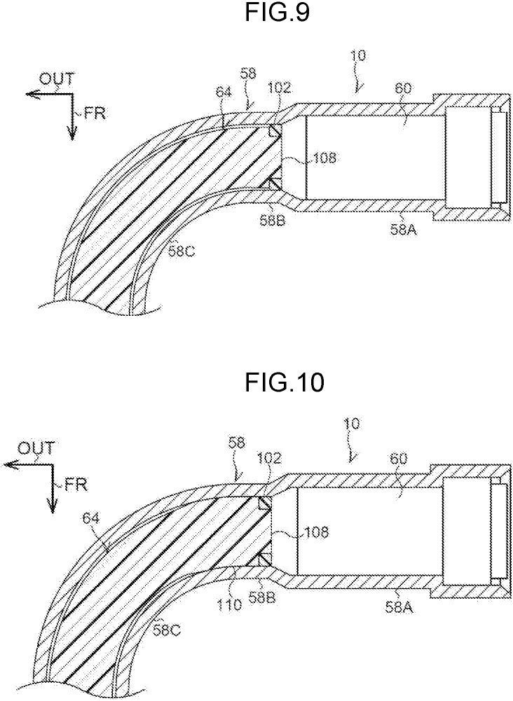

Meanwhile, as shown in FIG. 9, in a sixth embodiment, an attachment portion 108 is formed on the axial direction base end of the moving member 64. The attachment portion 108 has a shorter dimension in the radial direction (the direction orthogonal to the axial direction of the cylinder 58) than the other portion of the moving member 64 and is formed coaxially with respect to the other portion of the moving member 64. On the attachment portion 108 of the moving member 64 is disposed a sealing member 102. The sealing member 102 is annular and is in pressure contact with the insides of the first grooves 106 and the inner peripheral portion of the cylinder 58.

The fifth embodiment and the sixth embodiment with the above configurations have configurations where the sealing member 102 is provided on the axial direction base end portion of the moving member 64. For this reason, another member such as the sealing ball 62 does not come between the axial direction base end of the moving member 64 and the MGG 60. Because of this, the gap between the axial direction base end of the moving member 64 and the MGG 60 can be shortened, and the length of the first straight portion 58B of the cylinder 58 can be shortened.

Furthermore, the fifth embodiment and the sixth embodiment have configurations where the sealing ball 62 is replaced with the annular sealing member 102. Consequently, the same effects as the first embodiment can be obtained.

It will be noted that in the fifth embodiment there were two sealing members 102 and in the sixth embodiment there was one sealing member 102. However, there may also be three or more sealing members 102.

### Seventh Embodiment

As shown in FIG. 10, in a seventh embodiment, an enlarged diameter portion 110 is formed in the moving member 64. The enlarged diameter portion 110 is adjacent on the axial direction distal end side of the moving member 64 to the attachment portion 108 and has a larger dimension in the radial direction (the direction orthogonal to the axial direction of the cylinder 58 in the moving member 64) than the other portion of the moving member 64.

For this reason, inclination of the axial direction of the enlarged diameter portion 110 of the moving member 64 with respect to the axial direction of the cylinder 58 can be inhibited, and thus the axial direction of the annular sealing member 102 can be inhibited from inclining with respect to the axial direction of the cylinder 58. Because of this, the sealing member 102 can be inhibited from receiving strong interference at the first bend portion 58C of the cylinder 58, and the sealing member 102 can be inhibited from snapping.

Furthermore, except that the enlarged diameter portion 110 is formed, the configuration of the seventh embodiment is basically the same as that of the sixth embodiment. For this reason, basically the same effects as the sixth embodiment can be obtained.

### Eighth Embodiment to Tenth Embodiment

As shown in FIG. 11, in an eighth embodiment, three enlarged diameter portions 110 are formed a predetermined distance apart from each other in the axial direction on the axial direction base end portion of the moving member 64.

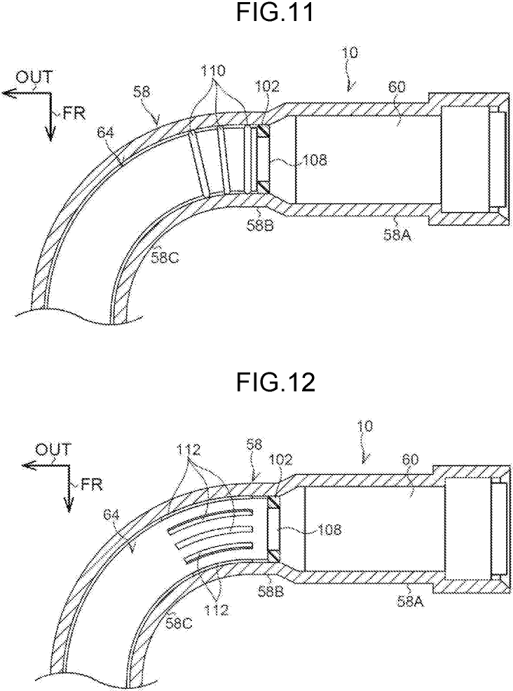

Meanwhile, as shown in FIG. 12, in a ninth embodiment, plural ribs 112 serving as enlarged diameter portions are formed on the outer peripheral portion of the moving member 64 on the axial direction base end portion of the moving member 64. The lengthwise direction of the ribs 112 coincides with the axial direction of the moving member 64, and the ribs 112 are provided a predetermined distance apart from each other in the circumferential direction of the moving member 64. The portions of the moving member 64 where the ribs 112 are formed have a larger dimension in the radial direction (the direction orthogonal to the axial direction of the cylinder 58 in the moving member 64) than the other portion of the moving member 64.

Furthermore, as shown in FIG. 13, in a tenth embodiment, plural dots 114 serving as enlarged diameter portions are formed. The dots 114 have substantially hemispherical shapes that project in a direction orthogonal to the axial direction of the moving member 64. The portions of the moving member 64 where the dots 114 are formed have a larger dimension in the radial direction (the direction orthogonal to the axial direction of the cylinder 58 in the moving member 64) than the other portion of the moving member 64.

Also with the eighth embodiment, the ninth embodiment, and the tenth embodiment, the same effects as the seventh embodiment can be obtained.

### Eleventh Embodiment

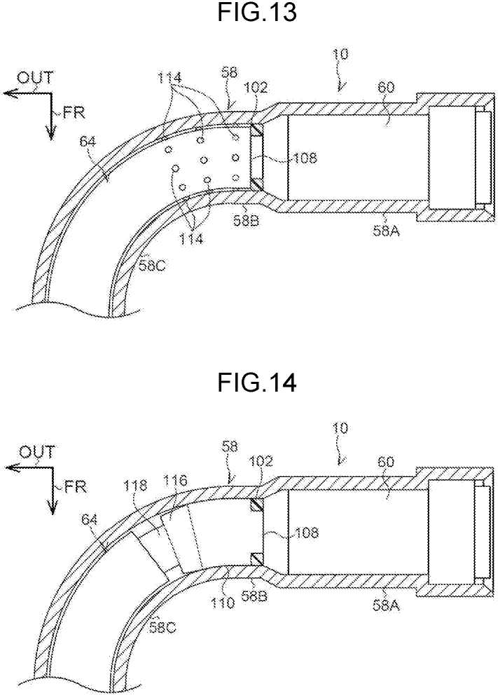

As shown in FIG. 14, in an eleventh embodiment, a reduced diameter portion 116 is formed in the moving member 64. The reduced diameter portion 116 is provided adjacent to an enlarged diameter portion 110 of the moving member 64 on the axial direction distal end side of the moving member 64 with respect to the enlarged diameter portion 110 of the moving member 64. The outer diameter dimension of the reduced diameter portion 116 on the axial direction base end of the moving member 64 is equal to the outer diameter dimension of the enlarged diameter portion 110 of the moving member 64, and the outer diameter dimension of the reduced diameter portion 116 becomes shorter heading from the axial direction base end of the moving member 64 to the axial direction distal end side.

Furthermore, a narrow neck portion 118 is formed in the moving member 64. The narrow neck portion 118 is provided adjacent to the reduced diameter portion 116 of the moving member 64 on the axial direction distal end side of the moving member 64 with respect to the reduced diameter portion 116 of the moving member 64. The narrow neck portion 118 has a shorter outer diameter dimension than the portion of the moving member 64 excluding the narrow neck portion 118. In an initial state of the moving member 64 (in a state before the MGG 60 is activated), the narrow neck portion 118 is disposed inside the first bend portion 58C of the cylinder 58.

In the present embodiment with this configuration, if an attempt is made to bend the moving member 64, bending stress concentrates in the narrow neck portion 118, bending is induced at the narrow neck portion 118 compared with the portions of the moving member 64 excluding the narrow neck portion 118, and the narrow neck portion 118 bends a great extent compared with the portions of the moving member 64 excluding the narrow neck portion 118. Because of this, bending at the enlarged diameter portion 110 of the moving member 64 can be inhibited.

Furthermore, the present embodiment has the same configuration as the seventh embodiment except that the narrow neck portion 118 is formed. For this reason, the same effects as the seventh embodiment can be obtained.

It will be noted that the eleventh embodiment had a configuration where the reduced diameter portion 116 was formed in the moving member 64. However, it may also have a configuration where the reduced diameter portion 116 is not formed in the moving member 64.

Furthermore, in the seventh embodiment to the eleventh embodiment, the cylinder 58 had the first straight portion 58B, and at least some of the enlarged diameter portion 110, the ribs 112, and the dots 114 were disposed inside the first straight portion 58B. However, the cylinder 58 may also have a configuration where it does not include the first straight portion 58B and where the first bend portion 58C is formed adjacent to the mounting portion 58A.

Moreover, in each of the above embodiments, the cylinder 58 had three bend portions, the first bend portion 58C, the second bend portion 58E, and the third bend portion 58G. However, the number of the bend portions may be one, two, or four or more.

The disclosure of Japanese Patent Application No. 2020-161485 filed on Sep. 25, 2020, is incorporated in its entirety herein by reference.

1-8. (canceled)

9. A webbing take-up device comprising:
a spool on which a webbing of a seat belt device is taken up as a result of the spool being rotated in a take-up direction;
a rotational member that rotates to one side, whereby the spool is rotated in the take-up direction;
a tubular cylinder whose axial direction distal end side is open, in whose axial direction base end portion a bend portion is set, and in which a straight portion is set on an axial direction base end side of the bend portion;
a fluid supply unit that is provided on the axial direction base end side of the cylinder and supplies a fluid to an inside of the cylinder at a time of a vehicle emergency; and
a moving member that is provided inside the cylinder, is moved toward the axial direction distal end side of the cylinder by pressure of the fluid, causes the rotational member to rotate to one side as a result of being moved in a state in which teeth of the rotational member are engaged with the moving member, and whose portion on the axial direction base end side of the cylinder is inside the straight portion of the cylinder,
wherein a sealing member is provided inside the straight portion of the cylinder, and
wherein an inside space of the cylinder is partitioned by the sealing member into an axial direction base end side of the sealing member and an axial direction distal end side of the sealing member.

10. The webbing take-up device of claim 9, wherein an axial direction base end portion of the moving member in the cylinder has a portion whose radial dimension in a direction orthogonal to an axis of the moving member is enlarged over that of an axial direction distal end portion of the moving member.

11. The webbing take-up device of claim 10, wherein the portion of the moving member whose radial dimension in the direction orthogonal to the axis of the moving member is enlarged is provided intermittently in at least one of an axial direction or a circumferential direction on an outer peripheral portion of the moving member.

12. The webbing take-up device of claim 10, wherein the moving member has, on the axial direction distal end side of the portion of the moving member whose radial dimension in the direction orthogonal to the axis of the moving member is enlarged, a portion whose radial dimension in the direction orthogonal to the axis of the moving member is smaller than that of the portion whose radial dimension in the direction orthogonal to the axis of the moving member is enlarged.

13. The webbing take-up device of claim 9, wherein a plurality of bend portions are set in the cylinder along an axial direction of the cylinder.

14. The webbing take-up device of claim 13, wherein three or more of the bend portions are set along the axial direction of the cylinder, and an axial direction of a bend in at least one of the bend portions intersects an axial direction of a bend in at least one of the other bend portions.

15. The webbing take-up device of claim 9, wherein, at the axial direction base end portion of the cylinder, an axial direction of the cylinder faces inward in a vehicle width direction.

16. The webbing take-up device of claim 9, comprising a sealing member that is provided at an axial direction base end portion of the moving member, is annular in a direction about an axis of the cylinder, and seals a gap between the cylinder and the moving member.
